(19) United States
(12) Patent Application Publication
(10) Pub. No.: US 2009/0198557 A1
(43) Pub. Date: Aug. 6, 2009

(54) TIMING COMMERCIAL OFFERS BASED ON LONG-TERM USER DATA

(75) Inventors: Gang Wang, San Diego, CA (US); Lisa C. Gevelber, Palo Alto, CA (US)

Correspondence Address: PVF -- INTUIT, INC.;c/o PARK, VAUGHAN & FLEMING LLP, 2820 FIFTH STREET, DAVIS, CA, 95618-7759, US

(73) Assignee: INTUIT INC., Mountain View, CA (US)

(21) Appl. No.: 12/024,020

(22) Filed: Jan. 31, 2008

(51) Int. Cl. G06Q 30/00

(52) U.S. Cl. 705/10

(57) ABSTRACT

One embodiment of the present invention provides a system that times commercial offers made to a user. During operation, the system starts by receiving financial history data for the user, wherein the financial history data includes purchase records for a set of purchases. The system then identifies a subset of purchases in the set of purchases, wherein the subset of purchases are semantically linked to a set of predetermined subjects. Next, the system identifies timing patterns in the subset of purchases based on timing information associated with the subset of purchases. The system then presents one or more commercial offers to the user at specific times based on the identified timing patterns.

### BACKGROUND

### Related Art

The present invention relates to the design of data-driven recommendation systems.

In the multi-billion-dollar online advertising market, a new type of e-commerce web application referred to as a “recommendation system” targets online users through personalized and data-driven recommendation techniques. Specifically, a recommendation system learns from the online activities of a large number of users and makes recommendations to users based on the observed interests of these users.

A significant number of the recommendation systems are designed to make commercial offers to web users. By showing the users highly relevant commercial offers, a web application can increase the likelihood of users performing transactions associated with the commercial offers. For example, the Amazon.com web site makes commercial recommendations over a wide variety of merchandise based on both user-specific information and user community information to make relevant recommendations to consumers.

In addition to making commercial offers highly relevant for a particular user profile and specific user community information, another important consideration in making commercial offers involves the timing of the offers. Note that a “right” offer made at a wrong time will not be attractive to a user, and will fail to generate revenue for the advertisers. For example, a vacation package offered to college students at the beginning of a semester will generally not attract any interest. However, making an offer at the right time for a specific user requires comprehensive knowledge of the user's long-term spending behavior. Unfortunately, this comprehensive, long-term spending data is generally not available to existing e-commerce web applications. Consequently, recommendation systems built for such e-commerce web applications are incapable of making accurate timing predictions for commercial offers which are directed to specific users.

### SUMMARY

One embodiment of the present invention provides a system that times commercial offers made to a user. During operation, the system starts by receiving financial history data for the user, wherein the financial history data includes purchase records for a set of purchases. The system then identifies a subset of purchases in the set of purchases, wherein the subset of purchases are semantically linked to a set of predetermined subjects. Next, the system identifies timing patterns in the subset of purchases based on timing information associated with the subset of purchases. The system then presents one or more commercial offers to the user at specific times based on the identified timing patterns.

In a variation on this embodiment, the system identifies the subset of purchases by performing a semantic analysis on a purchase record of each purchase to determine if the purchase is linked to at least one of the predetermined subjects. If so, the system adds the purchase into the subset of purchases.

In a further variation, the semantic analysis can involve a data-mining technique; an ontology analysis; a natural-language processing technique; a categorization technique; and a pattern-recognition technique.

In a further variation, the purchase record for a purchase can include a purchase time; vendor information; product information; a cost amount; automatically defined categorization information; user-defined categorization information; and other purchase-related information.

In a further variation, prior to identifying the timing patterns, the system tags each purchase in the subset of purchases with one or more semantically linked predetermined subjects and groups the subset of purchases based on the associated predetermined subjects.

In a further variation, the system identifies the timing patterns in the subset of purchases by identifying periodically recurring purchases tagged with the same predetermined subject.

In a further variation, the system identifies the timing patterns by performing a timing analysis on the purchases tagged with the same predetermined subject.

In a further variation, the timing analysis can include a Fourier analysis and other time-series-analysis techniques.

In a variation on this embodiment, the system makes commercial offers to the user at specific times based on the timing patterns. Specifically, the system receives a set of commercial offers, wherein each commercial offer in the set of commercial offers is associated with one or more predetermined subjects. Next, for an identified timing pattern and associated purchases, the system selects a subset of commercial offers which are associated with the same predetermined subject that matches a subject for the associated purchases. The system then filters the subset of commercial offers based on the identified timing pattern to obtain one or more commercial offers having timing constraints which are consistent with the identified timing pattern. Finally, the system presents the one or more commercial offers to the user at a specific time which is determined by the identified timing pattern.

In a further variation, the system creates a package offer by grouping the one or more coordinated commercial offers, and presents the package offer to the user at a specific time determined by the identified timing pattern.

In a variation on this embodiment, the predetermined subjects can include a family vacation; a birthday; an anniversary; a holiday; back-to-school purchases; car maintenance; and other spending-related events.

In a variation on this embodiment, the financial history data for the user is collected over a period of time which is long enough to detect timing patterns.

### BRIEF DESCRIPTION OF THE FIGURES

FIG. 1 illustrates a computing environment in accordance with an embodiment of the present invention.

FIG. 2 presents a flowchart illustrating the process of timing commercial offers made to a user in accordance with an embodiment of the present invention.

FIG. 3 presents a flowchart illustrating the process of making commercial offers based on the timing patterns in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

### Terminology

Throughout the specification, the terms “financial data,” “financial history,” “financial history data,” “user financial data,” “user financial history,” and “user financial history data,” are all used interchangeably. Furthermore, the terms “commercial offers,” and “offers” are used interchangeably.

### Overview

One embodiment of the present invention provides a technique for generating timed commercial offers for a user based on an understanding of the user financial history data accumulated over a long period of time.

In some embodiments of the present invention, the system data-mines the past purchase records of the user to identify significant purchases that are likely to be linked to available commercial offers. The system then performs a timing analysis on the identified significant purchases to identify timing patterns in these purchases.

In some embodiments of the present invention, the system identifies timing patterns in the past purchases based on the timing information associated with past purchases. The system then makes commercial offers to the user at the “right” time based on the identified timing patterns.

In some embodiments of the present invention, the system creates a package offer/deal for the user, and presents the package offer at the “right” time based on identified timing patterns in the past purchases.

### Computing Environment

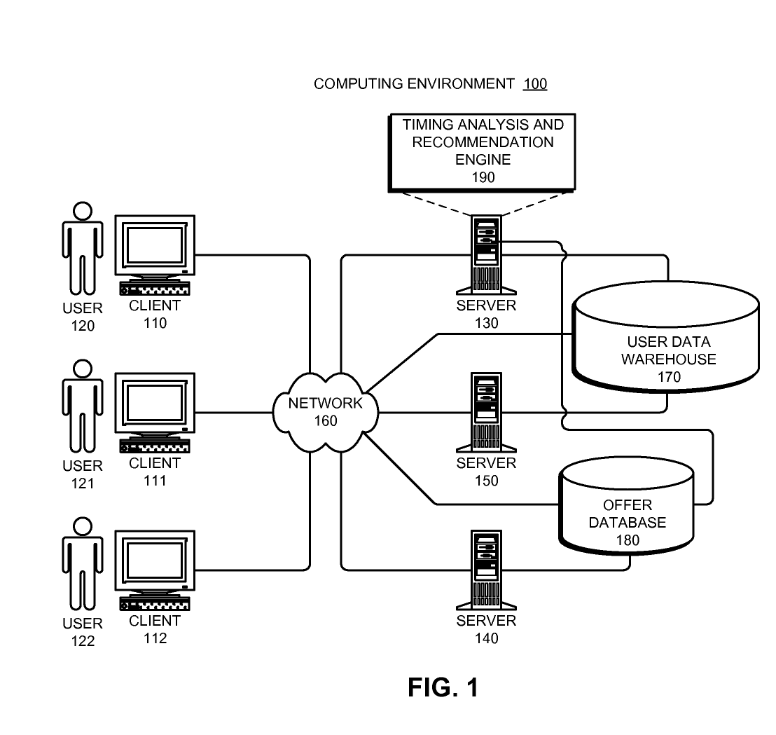

FIG. 1 illustrates a computing environment 100 for a recommendation system in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120-122, servers 130-150, network 160, user data warehouse 170, and offer database 180.

Clients 110-112 can include any node on a network including computational capability and including a mechanism for communicating across the network.

Similarly, servers 130-150 can generally include any node on a network including a mechanism for servicing requests from a client for computational and/or data storage resources.

Users 120-122 can include: an individual; a group of individuals; an organization; a group of organizations; a computing system; a group of computing systems; or any other entity that can interact with computing environment 100. In one embodiment of the present invention, users 120-122 are individual users targeted by the recommendation system.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

User data warehouse 170 can include any type of system for storing user financial data in non-volatile storage. This includes, but is not limited to, systems based upon magnetic, optical, or magneto-optical storage devices, as well as storage devices based on flash memory and/or battery-backed up memory. Note that user data warehouse 170 can be coupled to one or more servers (such as servers 130 and 150), to a client, and to network 160. In some embodiments of the present invention, user data warehouse 170 can store financial and non-financial data for users 120-122. This financial and non-financial data can include, but is not limited to, user financial history data, user financial transaction history data, user purchase data, user income data, user tax data, search history data, commercial offer viewing data, click data and print history data.

Note that some of the above data can be directly obtained from a user's financial software data file or from a user's financial institutions. Note that user's financial software data file can store complete purchase records and transaction data accumulated over a long period of time, for example many years. Note that both the financial and non-financial data can be updated periodically or in real time.

Offer database 180 can include any type of system for storing commercial offers in non-volatile storage. This includes, but is not limited to, systems based upon magnetic, optical, or magneto-optical storage devices, as well as storage devices based on flash memory and/or battery-backed up memory. Note that user offer database 180 can be coupled to one or more servers (such as servers 130 and 140), to a client, and to network 160. Note that some or all offers in the offer database 180 can have timing constraints, for example, timing constraints defined by starting dates and expiration dates. Note that the commercial offers in offer database 180 can be updated periodically or in real time.

Also note that server 130 comprises a timing analysis and recommendation engine 190. When executed on server 130, timing analysis and recommendation engine 190 can perform timing analyses on financial history data for users 120-122 stored in user data warehouse 170. Timing analysis and recommendation engine 190 can also match timing patterns in the financial history data to timing constraints of the commercial offers stored in offer database 180, thereby identifying commercial offers having the right timing for users 120-122. Additionally, timing analysis and recommendation engine 190 can present both single offers and package offers tailored for users 120-122 on clients 110-112. We now describe the timing analysis and recommendation engine 190 in more detail.

Note that different embodiments of the present invention may use different configurations, and are not limited to the configuration illustrated in computing environment 100.

### Process of Timing Commercial Offers

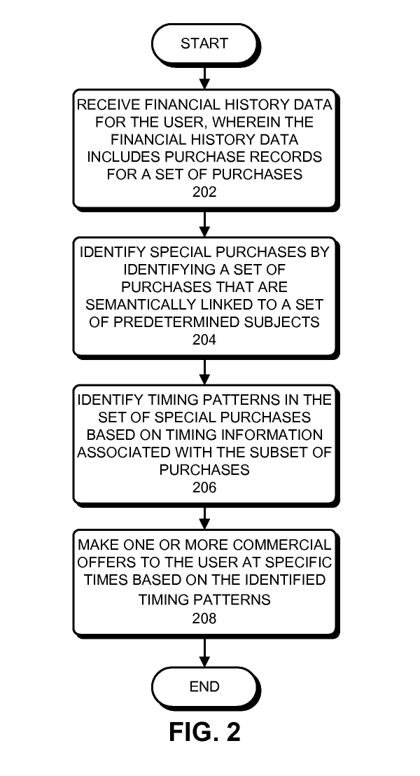

FIG. 2 presents a flowchart illustrating the process of timing commercial offers made to a user in accordance with an embodiment of the present invention.

During operation, the system starts by receiving financial history data for the user, wherein the financial history data includes purchase records for a set of purchases (step 202). In one embodiment, the system can retrieve user financial history data from user data warehouse 170 illustrated in FIG. 1. Note that the financial history data for a user can change with time, for example, by adding new financial transactions. Note that financial history data can include, but are not limited to, bank account activities, credit card charges, cash transactions, and tax data. In some embodiments of the present invention, the system can directly retrieve the financial history data for a user from the user's financial software data file. For example, such financial software can include, but are not limited to Quicken®, QuickBooks®, and TurboTax®.

Note that user purchases can be identified by transactions involving a credit card, cash, a check, a money order, or any other financial instrument. Furthermore, each purchase made can be associated with a purchase record, which can comprise one or more of: a purchase/transaction time; vendor information; product information; a cost amount; automatically defined categorization information (e.g., by user's financial software); user-defined categorization information (e.g., the user's comments on the purchase); and other purchase-related information. Note that embodiments of the present invention attempt to exploit some or all of above information, in particular, the timing information (i.e., the purchase/transaction time).

Identifying Special Purchases

Referring back to FIG. 2, the system next scans the financial history data to identify special purchases in the set of purchases. More specifically, identifying special purchases involves identifying a set of purchases that are semantically linked to a set of predetermined subjects (step 204). In one embodiment, the predetermined subjects can include, but are not limited to a family vacation, a birthday, an anniversary, a holiday, back-to-school purchases, and car maintenance.

Note that a recommendation system typically makes offers associated with one or a few specific subjects. For example, a travel website such as Expedia.com makes offers on vacation deals. Here “vacation” is regarded as a predetermined subject. Note that for a set of purchases that were made during a vacation event, it is not always easy to identify and tag these purchases as vacation-related purchases. For example, a dinner purchase can be either regular dining out after work, or can be a vacation dinner purchase. Similarly, a shopping activity can also be either a regular grocery purchase or a tourism purchase. For a targeted recommendation system, it is important to distinguish similar purchases that can be associated with different high-level semantics. Consequently, in one embodiment of the present invention, identifying special purchases involves performing a semantic analysis on the purchase record of an existing purchase to determine if the purchase is linked to at least one of the predetermined subjects. If so, the identified purchase is considered as likely to be linked to available commercial offers.

Note that the system can use one or multiple semantic analysis tools to perform the special purchase identification. One type of semantic analysis tools involves a data-mining technique. Another type of semantic analysis involves an ontology analysis. For example, to identify purchases associated with vacation, the system can analyze purchase records against a vacation-ontology-tree comprising such items as hotels, cruises, tickets (e.g., flights, amusement parks), etc. Other types of semantic analysis tools can involve a natural-language processing technique, a categorization technique, a pattern-recognition technique, and other semantic analysis techniques.

Note that one or more of the above-mentioned semantic analysis tools can be used in conjunction with one or more knowledge bases. Using these knowledge bases facilitates more accurately matching the purchase records to the predetermined subjects. Note that a knowledge base can be derived from collectively filtered purchases of a pool of users. Alternatively, a knowledge base can be provided by the vendor in the form of an ontology tree comprising vendor-related products. Moreover, a knowledge base can be a common-sense knowledge base which specifies a set of rules.

Note that the process of semantically linking purchases to a set of predetermined subjects is significantly more complicated than simply categorizing the purchases into a set of categories. Upon completing identification step 204, the system will be able to filter out and discard those regular purchase activities from special purchases that are likely to be linked to the predetermined subjects, and to the associated commercial offers.

In one embodiment of the present invention, after identifying the set of special purchases, the system tags each special purchase with one or more semantically linked predetermined subjects (i.e., provides an ID tag for each of the special purchases). In one embodiment, a group of purchases having the same ID tag that all occurred within a short period of time can be grouped together as a single purchase event. For example, a group of purchases having the same ID tag “vacation” that occurred during a two-week time period in summer can be grouped together and collectively identified with a new ID tag “summer vacation.” Note that we collectively refer to both ungrouped special purchases and grouped special purchases simply as “special purchases” hereafter.

Identifying Timing Patterns

Referring back to FIG. 2, after identifying the set of special purchases (both grouped and ungrouped), the system identifies timing patterns in the set of special purchases based on timing information associated with the subset of purchases (step 206). Note that the timing information can be obtained from the recorded purchase/transaction time for each purchase. In one embodiment, the timing-pattern identification is performed for each set of special purchases that have the same ID tag. In other words, the timing-pattern identification is performed on purchases identified as belonging to the same predetermined event.

In one embodiment, the user financial history data used to generate the set of special purchases is collected over a period of time which is long enough to detect timing patterns.

In one embodiment of the present invention, identifying the timing patterns based on the timing information involves identifying periodically recurring purchases having the same ID tag. For example, if the system concludes that the user has been performing regular car service (which can be one of the predetermined subjects) every three months, the system determines that the car service is a periodically recurring event. Consequently, the system can estimate the next service time based on the three-month service interval, and can present a timed commercial offer (e.g., an oil change coupon) to the user at around that time. In one embodiment of the present invention, identifying the timing patterns involves performing a timing analysis on the purchases having the same ID tag. In one embodiment, the timing analysis can include a Fourier analysis which is capable of identifying periodical purchase behaviors in the frequency domain. In other embodiments, other time-series-analysis can be used to perform the timing analysis.

Note that timing patterns which can be identified in special purchases are not limited to periodic purchase patterns. For example, other timing patterns that may be identified can include, but are not limited to, special purchases with increasing or decreasing recurring frequencies. Note that some other significant lifetime events, for example, new birth and relocation, may not have recurring time patterns. However, such events can also be detected using the present identification technique based on sufficient “evidences” accumulated over past purchase records. Although we describe identifying timing patterns based on an individual user's purchases, some embodiments can derive timing patterns based on collaborative-filtered results from a population of users.

Timing Offers

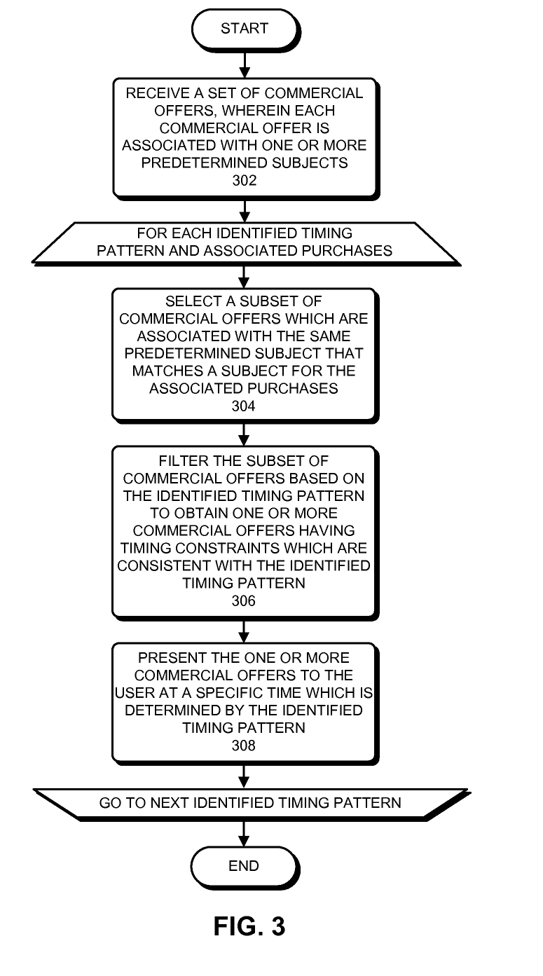

Referring back to FIG. 2, after identifying the timing patterns, the system next makes one or more commercial offers to the user at specific times based on the identified timing patterns (step 208). More specifically, FIG. 3 presents a flowchart illustrating the process of making commercial offers based on the timing patterns in accordance with an embodiment of the present invention.

During operation, the system receives a set of available commercial offers, wherein each commercial offer in the set of available commercial offers is associated with one or more predetermined subjects (step 302). Next, for each identified timing pattern and associated purchases, the system selects a subset of commercial offers which are associated with the same predetermined subject that matches a subject (i.e., an ID tag) for the associated purchases (step 304). The system then filters the subset of commercial offers based on the identified timing pattern to obtain one or more commercial offers having timing constraints which are consistent with the identified timing pattern (step 306). In one embodiment, the system approximates a date for a next purchase based on the obtained timing pattern, and selects an optimal offer or a combination of offers which have offer periods that contain the next purchase data. Next, the system presents the one or more commercial offers to the user at a specific time which is determined by the identified timing pattern (step 308).

Note that for a simple event such as an oil change service, the offer presented can be just a simple coupon for that event. For more significant events, such as a family vacation, the system may create a package offer by grouping a collection of coordinated commercial offers. These may include a cruise offer, hotel packages, airline tickets, etc. Note that all the offers in a package should have consistent timing to be used together. Finally, the system presents the package offer to the user at a specific time determined by the identified timing pattern.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for timing commercial offers made to a user, comprising:
receiving financial history data for the user, wherein the financial history data includes purchase records for a set of purchases;
identifying a subset of purchases in the set of purchases, wherein the subset of purchases are semantically linked to a set of predetermined subjects;
identifying timing patterns in the subset of purchases based on timing information associated with the subset of purchases; and
presenting one or more commercial offers to the user at specific times based on the identified timing patterns.

2. The method of claim 1, wherein identifying the subset of purchases involves:
for each purchase in the set of purchases, performing a semantic analysis on the associated purchase record to determine if the purchase is linked to at least one of the predetermined subjects; and
if so, adding the purchase into the subset of purchases.

3. The method of claim 2, wherein the semantic analysis can involve:
a data-mining technique;
an ontology analysis;
a natural-language processing technique;
a categorization technique; and
a pattern-recognition technique.

4. The method of claim 2, wherein the purchase record for a purchase can include:
a purchase time;
vendor information;
product information;
a cost amount;
automatically defined categorization information;
user-defined categorization information; and
other purchase-related information.

5. The method of claim 2, wherein prior to identifying the timing patterns, the method further comprises:
tagging each purchase in the subset of purchases with one or more semantically linked predetermined subjects; and
grouping the subset of purchases based on the associated predetermined subjects.

6. The method of claim 5, wherein identifying the timing patterns in the subset of purchases based on the timing information involves identifying periodically recurring purchases tagged with the same predetermined subject.

7. The method of claim 6, wherein identifying the timing patterns involves performing a timing analysis on the purchases tagged with the same predetermined subject.

8. The method of claim 7, wherein the timing analysis can include a Fourier analysis and other time-series-analysis techniques.

9. The method of claim 1, wherein making commercial offers to the user at specific times based on the timing patterns involves:
receiving a set of commercial offers, wherein each commercial offer in the set of commercial offers is associated with one or more predetermined subjects;
for an identified timing pattern and associated purchases,
selecting a subset of commercial offers which are associated with the same predetermined subject that matches a subject for the associated purchases;
filtering the subset of commercial offers based on the identified timing pattern to obtain one or more commercial offers having timing constraints which are consistent with the identified timing pattern; and
presenting the one or more commercial offers to the user at a specific time which is determined by the identified timing pattern.

10. The method of claim 9, wherein the method further comprises:
creating a package offer by grouping the one or more coordinated commercial offers; and
presenting the package offer to the user at a specific time determined by the identified timing pattern.

11. The method of claim 1, wherein the predetermined subjects can include:
a family vacation;
a birthday;
an anniversary;
a holiday;
back-to-school purchases;
car maintenance; and
other spending-related events.

12. The method of claim 1, wherein the financial history data for the user is collected over a period of time which is long enough to detect timing patterns.

13. A computer-readable storage medium storing instructions that when executed by a computer cause the computer to perform a method for timing commercial offers made to a user, the method comprising:
receiving financial history data for the user, wherein the financial history data includes purchase records for a set of purchases;
identifying a subset of purchases in the set of purchases, wherein the subset of purchases are semantically linked to a set of predetermined subjects;
identifying timing patterns in the subset of purchases based on timing information associated with the subset of purchases; and
presenting one or more commercial offers to the user at specific times based on the identified timing patterns.

14. The computer-readable storage medium of claim 13, wherein identifying the subset of purchases involves:
for each purchase in the set of purchases, performing a semantic analysis on the associated purchase record to determine if the purchase is linked to at least one of the predetermined subjects; and
if so, adding the purchase into the subset of purchases.

15. The computer-readable storage medium of claim 14, wherein the semantic analysis can involve:
a data-mining technique;
an ontology analysis;
a natural-language processing technique;
a categorization technique; and
a pattern-recognition technique.

16. The computer-readable storage medium of claim 14, wherein the purchase record for a purchase can include:
a purchase time;
vendor information;
product information;
a cost amount;
automatically defined categorization information;
user-defined categorization information; and
other purchase-related information.

17. The computer-readable storage medium of claim 14, wherein prior to identifying the timing patterns, the method further comprises:
tagging each purchase in the subset of purchases with one or more semantically linked predetermined subjects; and
grouping the subset of purchases based on the associated predetermined subjects.

18. The computer-readable storage medium of claim 17, wherein identifying the timing patterns in the subset of purchases based on the timing information involves identifying periodically recurring purchases tagged with the same predetermined subject.

19. The computer-readable storage medium of claim 18, wherein identifying the timing patterns involves performing a timing analysis on the purchases tagged with the same predetermined subject.

20. The computer-readable storage medium of claim 19, wherein the timing analysis can include a Fourier analysis and other time-series-analysis techniques.

21. The computer-readable storage medium of claim 13, wherein making commercial offers to the user at specific times based on the timing patterns involves:
receiving a set of commercial offers, wherein each commercial offer in the set of commercial offers is associated with one or more predetermined subjects;
for an identified timing pattern and associated purchases,
selecting a subset of commercial offers which are associated with the same predetermined subject that matches a subject for the associated purchases;
filtering the subset of commercial offers based on the identified timing pattern to obtain one or more commercial offers having timing constraints which are consistent with the identified timing pattern; and
presenting the one or more commercial offers to the user at a specific time which is determined by the identified timing pattern.

22. The computer-readable storage medium of claim 21, wherein the method further comprises:
creating a package offer by grouping the one or more coordinated commercial offers; and
presenting the package offer to the user at a specific time determined by the identified timing pattern.

23. The computer-readable storage medium of claim 13, wherein the predetermined subjects can include:
a family vacation;
a birthday;
an anniversary;
a holiday;
back-to-school purchases;
car maintenance; and
other spending-related events.

24. The computer-readable storage medium of claim 13, wherein the financial history data for the user is collected over a period of time which is long enough to detect timing patterns.

25. A system for timing commercial offers made to a user, comprising:
a receiving mechanism configured to receive financial history data for the user, wherein the financial history data includes purchase records for a set of purchases;
an identifying mechanism configured to identify a subset of purchases in the set of purchases, wherein the subset of purchases are semantically linked to a set of predetermined subjects;
wherein the identifying mechanism is further configured to identify timing patterns in the subset of purchases based on timing information associated with the subset of purchases; and
a presenting mechanism configured to present one or more commercial offers to the user at specific times based on the identified timing patterns.
